(19) United States
(12) Patent Application Publication
(10) Pub. No.: US 2025/0104293 A1
(43) Pub. Date: Mar. 27, 2025

(54) IMAGE PROCESSING SYSTEM, CONTROL METHOD, AND STORAGE MEDIUM

(71) Applicant: CANON KABUSHIKI KAISHA, Tokyo (JP)

(72) Inventors: HITOSHI NISHITANI, Tokyo (JP); KIYOKATSU IKEMOTO, Kanagawa (JP)

(21) Appl. No.: 18/893,171

(22) Filed: Sep. 23, 2024

(30) Foreign Application Priority Data
Sep. 26, 2023 (JP) 2023-163152

(51) Int. Cl. G06T 11/00; G06T 3/40; G06T 17/00

(52) U.S. Cl. CPC G06T 11/00; G06T 3/40; G06T 17/00

(57) ABSTRACT

A system includes a capturing apparatus, an external apparatus, and a recording apparatus, wherein the capturing apparatus includes a capturing unit configured to capture a plurality of two-dimensional images having parallax according to an instruction from among instructions of a plurality of types, wherein at least any one of the capturing apparatus and the external apparatus includes an acquisition unit configured to acquire the captured plurality of two-dimensional images regardless of a type of the instruction, and a first generation unit configured to generate an image according to the type of the instruction based on the acquired plurality of two-dimensional images, and wherein the recording apparatus records the captured plurality of two-dimensional images in an association manner.

### BACKGROUND

### Technical Field

The aspect of the embodiments relates to an image processing system, a control method, and a storage medium.

### Description of the Related Art

Conventionally, image processing which employs a phase-difference distance detection technique as a technique to be applied to a digital still camera and a digital video camera has been known. In the distance detection technique, optical images (hereinafter, respectively called “image A” and “image B”) formed by light fluxes passing through different pupil regions are acquired. Then, an image deviation amount (also called “parallax”) is calculated as the amount of relative positional deviation between the images A and B, and the image deviation amount is converted into a defocus amount through a conversion coefficient based on a baseline length indicating a distance between the centroids of the images A and B formed on a pupil of the lens.

Japanese Patent Application Laid-Open No. 2015-220510 discusses a technique which uses the images A and B in normal still image capturing or normal moving image capturing to execute development processing on an addition RAW image in which the images A and B are added together, in a case where image capturing is not executed.

Because the above-described defocus amount can be calculated with respect to the pixels within all or a part of a region of an image sensor, a distance map can be calculated with respect to all or a part of an object region, so that it is possible to calculate a three-dimensional shape of the object. Further, a three-dimensional shape of the object can also be calculated by using the images captured by two cameras having parallax as the images A and B, by employing a method using a so-called stereo camera, which executes image capturing by arranging two cameras.

Japanese Patent No. 7187182 discusses a technique which generates three-dimensional shape data describing an object shape, based on a plurality of images captured by a plurality of cameras for capturing the object images in a plurality of directions.

There is a case where the user would like to use image data such as three-dimensional shape data in an apparatus different from an apparatus which generates the image data, or would like to use the image data for another purpose, after the image data such as the three-dimensional shape data is generated based on a plurality of images. However, resolution and a data size of the generated image data such as the three-dimensional shape data may not be appropriate for the apparatus in which the image data is to be used, or the purpose of using the image data.

### SUMMARY

According to an aspect of the embodiments, a system includes a capturing apparatus, an external apparatus, and a recording apparatus, wherein the capturing apparatus includes a capturing unit configured to capture a plurality of two-dimensional images having parallax according to an instruction from among instructions of a plurality of types, wherein at least any one of the capturing apparatus and the external apparatus includes an acquisition unit configured to acquire the captured plurality of two-dimensional images regardless of a type of the instruction, and a first generation unit configured to generate an image according to the type of the instruction based on the acquired plurality of two-dimensional images, and wherein the recording apparatus records the captured plurality of two-dimensional images in an association manner.

Further features of the disclosure will become apparent from the following description of exemplary embodiments with reference to the attached drawings.

### BRIEF DESCRIPTION OF THE DRAWINGS

FIG. 1 is a block diagram illustrating an example of a configuration of an image capturing apparatus.

FIGS. 2A and 2B are diagrams illustrating examples of color filters arranged on an image sensor unit, and FIG. 2C is a diagram illustrating an example of the image sensor unit.

FIG. 3 is a block diagram illustrating an example of a configuration of an external apparatus.

FIG. 4 is a block diagram illustrating an example of an overall configuration of an image processing system.

FIG. 5 is a flowchart illustrating an example of image capturing processing.

FIG. 6 is a flowchart illustrating an example of reproduction processing.

### DESCRIPTION OF THE EMBODIMENTS

Hereinafter, exemplary embodiments according to the disclosure are described with reference to the appended drawings.

First, terms used for the descriptions of a present exemplary embodiment are described. A term “two-dimensional image” refers to image data in any format, e.g., a RAW format, a developed bitmap format, and a compressed Joint Photographic Experts Group (JPEG) format, output by an image sensor unit such as a complementary metal oxide semiconductor (CMOS) sensor or a charge-coupled device (CCD) sensor, in which light intensity information is allocated to each of pixels arrayed in a two-dimensional state. A term “two-dimensional RAW image” refers to a RAW image itself output from the image sensor unit, from among two-dimensional images. A term “a plurality of two-dimensional images” does not simply refer to the number of files, and also refers to a plurality of two-dimensional image data arrays. For example, a plurality of two-dimensional image data arrays put into one file is also called a plurality of two-dimensional images.

A term “three-dimensional model” refers to an aggregation of data including a polygon as three-dimensional shape data, to which surface image data of the polygon, such as a texture, a UV map, and material data are added. The three-dimensional model is generated based on a plurality of two-dimensional images having parallax. Various conventional methods can be used with respect to a technique for generating a three-dimensional model based on a plurality of two-dimensional images having parallax.

A term “image processing” refers to overall image adjustment processing, e.g., so-called white balance adjustment processing, color grading processing for adjusting colors for each gradation, and adjustment processing for adjusting brightness for each region by selecting a region, executed on the two-dimensional image. General-purpose methods can be employed for algorithms of the image processing executed on the two-dimensional image and software for executing these algorithms.

A term “an image capturing unit for capturing a plurality of two-dimensional images having parallax” refers to an image sensor unit capable of acquiring two-dimensional images having parallax, from which the three-dimensional model is generated. The plurality of two-dimensional images having parallax can be acquired by a camera which captures images A and B formed by light fluxes passing through different pupil regions, a stereo camera, or a plurality of cameras arranged.

A term “two-dimensional still image” refers to an image captured through a normal still-image capturing operation. An object shape and an object position are fixed at a specific time, and a view point and a line-of-sight direction of the object cannot be changed. A term “two-dimensional moving image” refers to an image captured by a normal moving-image capturing operation, in which two-dimensional still images are continuously connected to each other at a predetermined frame rate. Although an object shape and an object position temporally change within a range the object is being captured, a view point and a line-of-sight direction of the object cannot be changed.

A term “three-dimensional still image” refers to a still image generated from a three-dimensional model. Although an object shape and an object position are fixed at a specific time, a view point and a line-of-sight direction of the object can be changed. A term “thee-dimensional moving image” refers to an image in which still images generated from a three-dimensional model are continuously connected to each other at a predetermined frame rate. An object shape and an object position temporally change within a range the object is being captured, and a view point and a line-of-sight direction of the object can be changed.

In the three-dimensional still image and the three-dimensional moving image, a viewpoint and a line-of-sight direction of a three-dimensional model can be changed. Although a certain limitation is placed on a range of the viewpoint or the line-of-sight direction changeable in the three-dimensional still image/moving image depending on the conditions such as a baseline length and a line-of-sight direction of the two-dimensional image from which the three-dimensional still image/moving image is generated, a sense of solidity and depth which cannot be acquired from the two-dimensional image can be acquired from the three-dimensional still image/moving image. Further, “three-dimensional model”, “three-dimensional still image”, and “three-dimensional moving image” are collectively called “three-dimensional model or the like”.

An image processing system according to the present exemplary embodiment includes an image capturing apparatus 100, an information terminal 300, and a recording apparatus 400, which are communicably connected to each other.

### Configuration of Image Capturing Apparatus 100

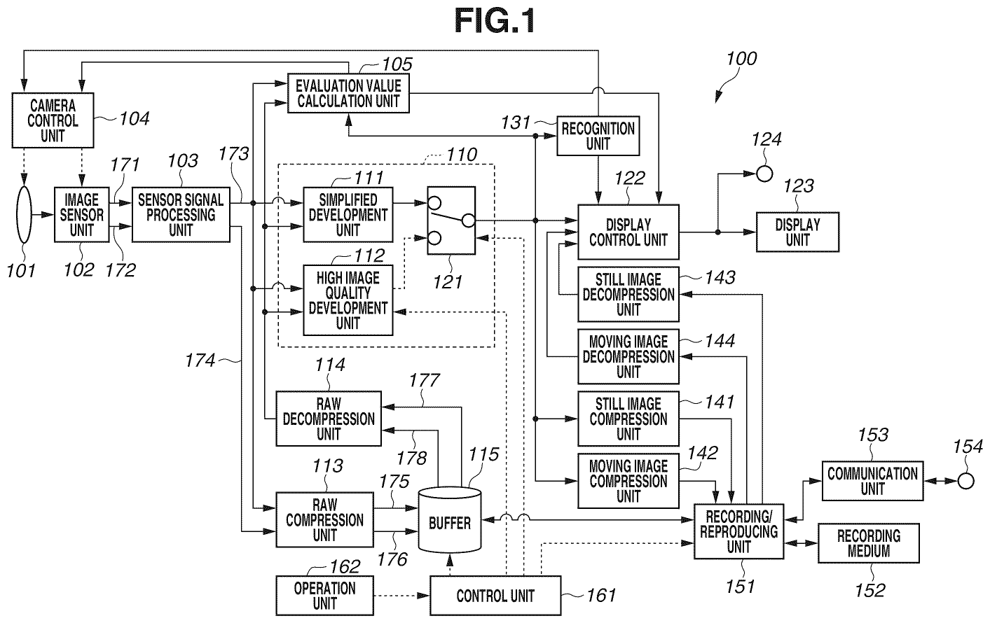

FIG. 1 is a block diagram illustrating an example of a configuration of the image capturing apparatus 100.

The image capturing apparatus 100 records image information acquired by capturing an object image in a recording medium. The image capturing apparatus 100 further includes a function for reproducing image information from the recording medium and developing and displaying the image information, and a function for transmitting and receiving the image information to/from the information terminal 300 and the recording apparatus 400.

Except for the physical devices such as an image sensor, a display element, an input device, and a terminal, respective blocks included in the image capturing apparatus 100, are configured to function as hardware by using dedicated logic circuits and memories. However, the blocks may be configured to function as software by making a computer such as a central processing unit (CPU) execute a processing program stored in a memory. Further, although the image capturing apparatus 100 according to the present exemplary embodiment is described as a digital camera, the image capturing apparatus 100 may be an electronic device such as a personal computer, a mobile phone, a smartphone, a personal digital assistance (PDA), a tablet terminal, or a digital video camera.

In FIG. 1, a control unit 161 includes a CPU and a memory which stores a control program executed by the CPU, and the control unit 161 controls the entire processing implemented by the image capturing apparatus 100. An operation unit 162 includes input devices such as keys, buttons, and a touch panel through which the user issues instructions to the image capturing apparatus 100. The control unit 161 detects an operation signal transmitted from the operation unit 162, and executes control to make the physical devices and the respective blocks operate according to the operation. A display unit 123 includes a liquid crystal display (LCD) for displaying images captured or reproduced by the image capturing apparatus 100, a menu screen, and various types of information.

When an instruction to start executing image capturing is issued through the operation unit 162, an optical image of an object as an image capturing target is input via the image capturing optical unit 101, so that the optical image is formed on the image sensor unit 102. When image capturing is executed, operations executed by the image capturing optical unit 101 and the image sensor unit 102 are controlled by a camera control unit 104 based on calculation results of evaluation values with respect to an aperture, a focus, and a camera-shake, acquired by an evaluation value calculation unit 105 and object information extracted by a recognition unit 131.

The image sensor unit 102 includes an image sensor such as a CCD sensor or a CMOS sensor, and converts light passing through color filters of red, green, and blue (RGB) arranged for each pixel, into electric signals.

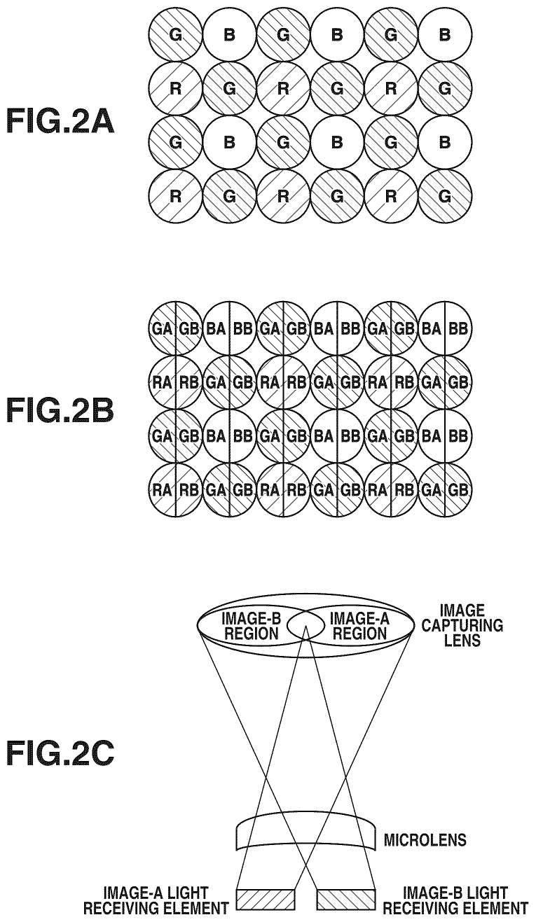

FIGS. 2A and 2B are diagrams illustrating examples of color filters arranged on the image sensor unit 102, which also illustrate pixel arrays of images processed by the image capturing apparatus 100. As illustrated in FIGS. 2A and 2B, color filters of red (R), green (G), and blue (B) are respectively arranged on the pixels in a mosaic-like state in which a set of four pixels in 2-by-2 matrices, consisting of one red pixel, one blue pixel, and two green pixels, is arranged regularly. The above-described pixel arrangement is generally called “Bayer arrangement.” In addition, FIG. 2A illustrates one pixel which includes one region, and FIG. 2B illustrates one pixel which includes two divided regions A and B. In the present exemplary embodiment, the image sensor unit 102 employing the image sensor (divided pixel sensor) illustrated in FIG. 2B is described.

FIG. 2C illustrates an example of the image sensor unit 102 employing the image sensor illustrated in FIG. 2B. An image-A light receiving element receives light passing through an image-A region of an image capturing lens, and an image-B light receiving element receives light passing through an image-B region of the image capturing lens. By reception of light passing through the image-A region and the image-B region of the same image capturing lens by a divided pixel via a single microlens, two image signals having parallax can be acquired. In other words, the image sensor unit 102 can capture a plurality of two-dimensional images having parallax.

Respective pieces of image information acquired from the regions A and B illustrated in FIG. 2B are converted into electric signals by the image sensor unit 102. Then, these electric signals are individually input to a sensor signal processing unit 103 as signals 171 and 172, and restoration processing of the pixel value is executed. In the restoration processing, with respect to values of missing pixels and values of pixels with low reliability in the image sensor unit 102, processing for interpolating a pixel value as a restoration target by using peripheral pixel values and processing for subtracting a predetermined offset value are executed. In the present exemplary embodiment, image information output from the sensor signal processing unit 103 is called a RAW image, which means a raw (undeveloped) image.

Further, a signal 173 in FIG. 1 represents addition information (addition RAW image) in which image information acquired from the region A and image information acquired from the region B in FIG. 2B are added. On the other hand, a signal 174 in FIG. 1 represents subtraction information (difference RAW image) in which subtraction is executed on the image information acquired from the region A and image information acquired from the region B. The information amount of the addition RAW image is greater than the image information amount of the region A or B by 1-bit, and the information amount of the difference RAW image is less than the image information amount of the region A or B by several bits. Accordingly, it is possible to reduce a data amount in comparison to the case where two RAW images are simply saved. However, the sensor signal processing unit 103 may output the image information of the region A (image-A RAW image) and the image information of the region B (image-B RAW image).

The RAW image is developed by a development unit 110. The development unit 110 includes a plurality of different development processing units. Specifically, the development unit 110 includes a simplified development unit 111 as a first development unit, a high image quality development unit 112 as a second development unit, and a switch unit 121 for selecting information output from the simplified development unit 111 and the high image quality development unit 112. Each of the simplified development unit 111 and the high image quality development unit 112 executes de-Bayer processing (de-mosaic processing) on the RAW image to convert the RAW image into a signal consisting of a luminance and a color difference, and executes so-called development processing to remove noise included in the signal, correct optical distortion, and optimize the image. In comparison to the simplified development unit 111, the high image quality development unit 112 executes the above-described processing with a higher degree of processing accuracy. Therefore, a developed image can be acquired with image quality higher than that of a developed image acquired by the simplified development unit 111. However, a processing load of the high image quality development unit 112 becomes greater. Accordingly, the high image quality development unit 112 is not specialized in real-time development executed in concurrence with image capturing, but the high image quality development unit 112 can execute distributed processing over a certain period of time after image capturing is executed. As described above, by executing the high-image quality development over a certain period of time after image capturing, instead of executing the high-image quality development while image capturing is being executed, it is possible to reduce a circuit size and an increase (peak) of power consumption.

On the other hand, the image quality acquired by the simplified development unit 111 is lower than the image quality acquired by the high image quality development unit 112. However, a processing amount related to development executed by the simplified development unit 111 is smaller than a processing amount related to the high-image quality development. Therefore, the simplified development unit 111 can execute development processing at high speed while image capturing is being executed. Because the processing load of the simplified development unit 111 is small, the simplified development unit 111 is used when real-time development is executed in concurrence with the image capturing operation. The switch unit 121 is switched by the control unit 161 through the control executed depending on the operation contents instructed from the user through the operation unit 162 or the operation mode that is being executed.

In the present exemplary embodiment, although the simplified development unit 111 and the high image quality development unit 112 are independently included in the development unit 110, one development unit may exclusively execute the simplified development processing and the high image quality development processing by changing the operation modes. After the development unit 110 executes development processing on the image information, a display control unit 122 executes predetermined display processing on the image information and displays the image information on the display unit 123. Further, the developed image information may be output to a display device externally connected through an image output terminal 124. The image output terminal 124 includes a general-purpose interface such as a high-definition multimedia interface (HDMI) (registered trademark) or a serial digital interface (SDI).

The image information developed by the development unit 110 is also supplied to the evaluation value calculation unit 105. The evaluation value calculation unit 105 calculates evaluation values indicating a focus state and an exposure state from the image information. The image information developed by the development unit 110 is also supplied to the recognition unit 131. The recognition unit 131 has function for detecting and recognizing object information included in the image information. For example, the recognition unit 131 outputs information describing a position of a face when the face is detected from the image information displayed on a screen, and further executes authentication of a particular person based on information about a feature of the face.

The image information developed by the development unit 110 is also supplied to a still image compression unit 141 and a moving image compression unit 142. The still image compression unit 141 is used when the image information is compressed as a still image. The moving image compression unit 142 is used when the image information is compressed as a moving image. Each of the still image compression unit 141 and the moving image compression unit 142 executes high-efficiency coding (compression coding) on target image information to generate image information having the compressed information amount, and converts the generated image information into an image file (a still image file or a moving image file). A still image can be compressed through a compression method such as Joint Photographic Experts Group (JPEG), and a moving image can be compressed through a compression method such as Moving Picture Experts Group Phase 2 (MPEG-2), H.264/MPEG-4 Advanced Video Coding (AVC), or H.265/MPEG-H High Efficiency Video Coding (HEVC).

A RAW compression unit 113 executes high-efficiency coding on each of the addition RAW image and the difference RAW image output from the sensor signal processing unit 103 through techniques such as wavelet conversion and difference encoding. Then, the RAW compression unit 113 converts the encoded addition RAW image and the encoded difference RAW image into compressed addition RAW image data and compressed difference RAW image data, and stores the RAW image data in a buffer (temporary storage memory) 115. The RAW image data can be retained in the buffer 115 and read out again. However, the RAW image data may be relocated to and recorded in another recording medium (deleted from the buffer 115) after being stored in the buffer 115.

A RAW file including the RAW image data and the above-described still image file and moving image file are recorded in a recording medium 152 by a recording/reproducing unit 151. The recording medium 152 is a built-in type large-capacity memory, a hard disk, or a removable memory card. The recording/reproducing unit 151 can also read out the still image file, the moving image file, and the RAW file from the recording medium 152.

The recording/reproducing unit 151 can record and read various files in/from the recording apparatus 400 via a communication unit 153. The communication unit 153 can access the internet and an external device through wireless/wired communication by using a communication terminal 154. In addition, based on the instructions from the control unit 161, the recording/reproducing unit 151 can record a plurality of RAW images output from the sensor signal processing unit 103 in the recording medium 152 or the recording apparatus 400 without compressing the RAW images.

When reproduction is started, the recording/reproducing unit 151 acquires a desired file from the recording medium 152 directly or via the communication unit 153, and reproduces the acquired file. When a reproduction target file is a RAW file, the recording/reproducing unit 151 stores the RAW image data stored in the acquired RAW file in the buffer 115. When a reproduction target file is a still image file, the recording/reproducing unit 151 supplies still image data stored in the acquired still image file to a still image decompression unit 143. When a reproduction target file is a moving image file, the recording/reproducing unit 151 supplies moving image data stored in the acquired moving image file to a moving image decompression unit 144.

A RAW decompression unit 114 reads out the RAW image data stored in the buffer 115 and generates a RAW image by decoding the compressed RAW image data. The RAW image acquired by the RAW decompression unit 114 through the decompression processing executed on the RAW image data is supplied to the simplified development unit 111 and the high image quality development unit 112 included in the development unit 110.

The still image decompression unit 143 decodes and decompresses the received still image data, and supplies the decompressed still image data to the display control unit 122 as a reproduction image of the still image. The moving image decompression unit 144 decodes and decompresses the received moving image data, and supplies the decompressed moving image data to the display control unit 122 as a reproduction image of the moving image (i.e., reproduction moving image).

Further, the image capturing apparatus 100 can remotely be operated by the information terminal 300 by communicating with the information terminal 300. Specifically, the image capturing apparatus 100 can transmit a live-view image captured by the image sensor unit 102 to the information terminal 300, and can capture and transmit a plurality of two-dimensional images having parallax according to an image capturing instruction notified from the information terminal 300. The above-described operation executed by the image capturing apparatus 100 in the image processing system is described below.

### Configuration of Information Terminal 300

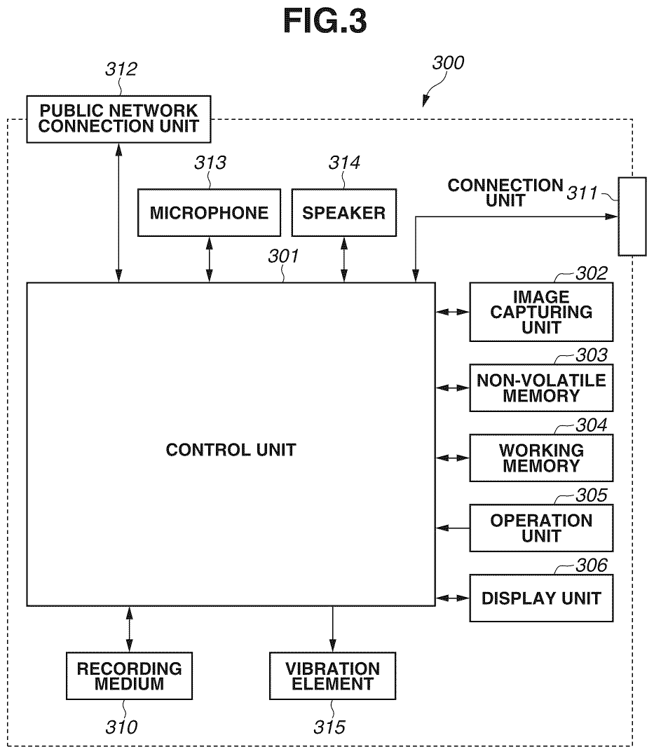

FIG. 3 is a block diagram illustrating an example of a configuration of the information terminal 300 serving as an external apparatus. Although the information terminal 300 according to the present exemplary embodiment is described as a smartphone or a personal computer (PC), the information terminal 300 can be an electronic device capable of communicating with the image capturing apparatus 100.

The information terminal 300 includes a control unit 301, an image capturing unit 302, a non-volatile memory 303, a working memory 304, an operation unit 305, a display unit 306, a recording medium 310, a connection unit 311, a public network connection unit 312, a microphone 313, a speaker 314, and a vibration element 315.

The control unit 301 controls the units included in the information terminal 300 according to an input signal and a program. In addition, a plurality of pieces of hardware may share the processing to control the entire information terminal 300, instead of making the control unit 301 control the entire information terminal 300.

The image capturing unit 302 acquires an image (called a terminal image) by capturing an object (i.e., actual space). The image capturing unit 302 includes a lens. The image capturing unit 302 converts light of an object image formed by the lens into an electric signal. The image capturing unit 302 executes noise reduction processing on the electric signal to acquire digital data as a terminal image. After the terminal image is stored in a buffer memory, the control unit 301 executes predetermined arithmetic processing and records the terminal image in the recording medium 310.

The non-volatile memory 303 is an electrically-erasable/recordable non-volatile memory. The non-volatile memory 303 stores an operating system (OS) as basic software executed by the control unit 301 and various programs. A program for communicating with the image capturing apparatus 100 is retained in the non-volatile memory 303. This program is installed in the information terminal 300 as a camera communication application. The processing executed by the information terminal 300 is implemented by a program provided by the camera communication application. Further, the camera communication application includes a program for using a basic function (e.g., a wireless communication function and a vibration function) of the OS installed in the information terminal 300. Further, the camera communication application has a remote image capturing function which enables the information terminal 300 to remotely control and make the image capturing apparatus 100 execute image capturing while displaying a camera image as a live-view image acquired from the image capturing apparatus 100 on the information terminal 300. Furthermore, the camera communication application includes a setting change function for remotely changing the setting of the image capturing apparatus 100. In addition, the OS of the information terminal 300 may have a program for implementing the processing according to the present exemplary embodiment.

The working memory 304 is used as a buffer memory for temporarily saving the terminal image. The working memory 304 is also used as a memory for storing an image to be displayed on the display unit 306 and a working area of the control unit 301.

The operation unit 305 accepts an instruction the user has issued to the information terminal 300. For example, the operation unit 305 includes a power button for accepting the power ON/OFF instructions to the information terminal 300. The operation unit 305 also includes an operation member such as a touch panel formed on the display unit 306.

The display unit 306 displays a terminal image, a camera image, and characters used for a dialogical operation. In addition, the display unit 306 does not always have to be built into the information terminal 300. The information terminal 300 may simply connect to the display unit 306 and execute display control on the display unit 306.

The recording medium 310 records a terminal image output from the image capturing unit 302 and a camera image received from the image capturing apparatus 100. The recording medium 310 is a built-in type large-capacity memory, a hard disk, or a removable memory card. In other words, the information terminal 300 may at least be accessible to the recording medium 310.

The connection unit 311 is an interface for connecting the information terminal 300 to the image capturing apparatus 100. The information terminal 300 can exchange data with the image capturing apparatus 100 via the connection unit 311. The connection unit 311 includes an interface for wirelessly communicating with the image capturing apparatus 100. The control unit 301 establishes the wireless communication between the information terminal 300 and the image capturing apparatus 100 by controlling the connection unit 311.

The public network connection unit 312 is an interface used to execute communication using a public wireless network. The information terminal 300 can execute phone call and data communication via the public network connection unit 312. When the information terminal 300 executes phone call, the control unit 301 acquires ambient sound through the microphone 313, and generates (outputs) the sound through the speaker 314.

The vibration element 315 vibrates based on a driving voltage output from the control unit 301. Therefore, the information terminal 300 itself vibrates along with the vibration of the vibration element 315.

Further, the information terminal 300 can remotely operate the image capturing apparatus 100 by communicating with the image capturing apparatus 100. Specifically, the information terminal 300 can acquire a plurality of two-dimensional images having parallax which the image capturing apparatus 100 has acquired according to the image capturing instruction notified to the image capturing apparatus 100. The above-described operation executed by the information terminal 300 in the image processing system is described below.

### Configuration of Image Processing System

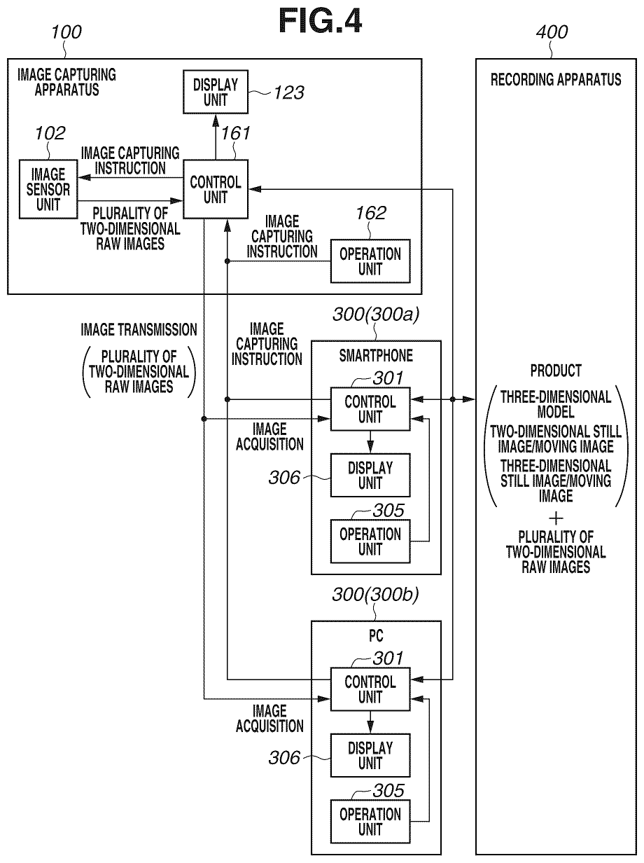

FIG. 4 is a block diagram illustrating an example of the entire configuration of the image processing system according to the present exemplary embodiment.

The image processing system includes the image capturing apparatus 100, the information terminals 300, and the recording apparatus 400. Description and illustration of the configuration already described in the above are omitted as appropriate.

The image capturing apparatus 100 includes the control unit 161, the operation unit 162, the display unit 123, and the image sensor unit 102 which captures a plurality of two-dimensional images having parallax. The control unit 161 accepts an image capturing instruction from the user via the operation unit 162. The control unit 161 makes the image sensor unit 102 capture a plurality of two-dimensional images having parallax by controlling the image sensor unit 102 according to the image capturing instruction.

Each of the information terminals 300 is communicably connected to the image capturing apparatus 100 through wireless or wired connection. The information terminals 300 include a smartphone 300a and a personal computer (PC) 300b. Each of the information terminals 300 includes a control unit 301, an operation unit 305, and a display unit 306. The control unit 301 accepts an image capturing instruction from the user via the operation unit 305. When the control unit 301 accepts the image capturing instruction, the control unit 301 notifies the image capturing instructions to the image capturing apparatus 100. Then, the control unit 161 of the image capturing apparatus 100 controls the image sensor unit 102 according to the notified image capturing instruction to make the image sensor unit 102 capture a plurality of two-dimensional images having parallax.

A plurality of types of image capturing instructions are input to the image capturing apparatus 100 and the information terminal 300 via the operation units 162 and 305. The user issues an image capturing instruction to the image sensor unit 102 of the image capturing apparatus 100 by selecting an image capturing instruction appropriate for the purpose of image capturing from the plurality of types of image capturing instructions. The image capturing instructions according to the present exemplary embodiment include image capturing instructions for capturing a two-dimensional still image, a three-dimensional still image, a two-dimensional moving image, and a three-dimensional moving image, and an image capturing instruction for continuously capturing bracket images under the different image capturing conditions.

The image sensor unit 102 transmits a plurality of two-dimensional images captured according to the image capturing instruction to an apparatus which accepts the image capturing instruction, specifically, the control unit 161 of the image capturing apparatus 100 or the information terminal 300. As described above, the image sensor unit 102 can communicate with the control unit 161, and can also communicate with the information terminal 300 via the control unit 161.

The image capturing apparatus 100 or the information terminal 300 can acquire a plurality of two-dimensional images captured by the image sensor unit 102 regardless of a type of the image capturing instruction. The effect acquired from the above-described configuration is described below.

In addition, in one embodiment, the two-dimensional images acquired by the image capturing apparatus 100 or the information terminal 300 are two-dimensional RAW images. This is because the RAW image includes a greatest amount of information, so that the RAW image is suitable for image processing. However, if the amount of information is sufficient for the apparatus or the purpose of use, compressed RAW image data or a developed RAW image may be acquired instead of acquiring the RAW image because the effect equivalent to the effect acquired from the RAW image can also be acquired.

The image capturing apparatus 100 or the information terminal 300 accepts the image capturing instruction from the user, and generates an image according to the image capturing instruction based on the acquired two-dimensional RAW image. In a case where the image capturing apparatus 100 or the information terminal 300 accepts an image capturing instruction for capturing a two-dimensional still image or a two-dimensional moving image, a two-dimensional still image or a two-dimensional moving image is generated by developing the two-dimensional RAW image. On the other hand, in a case where the image capturing apparatus 100 or the information terminal 300 accepts an image capturing instruction for capturing a three-dimensional still image or a three-dimensional moving image, the image capturing apparatus 100 or the information terminal 300 generates a three-dimensional model from the plurality of two-dimensional RAW images with reference to the known information such as information about a baseline length between the two-dimensional RAW images, and generates a three-dimensional still image or a three-dimensional moving image. Generation of a three-dimensional model is implemented by calculating constituent elements of the three-dimensional model, such as a polygon, a texture, a UV map, and material data, from plurality of two-dimensional RAW images. This calculation method is not limited in particular, and various calculation methods can be employed.

As described above, the image capturing apparatus 100 or the information terminal 300 generates an image from the plurality of acquired two-dimensional RAW images according to the image capturing instruction.

The image capturing apparatus 100 or the information terminal 300 reproduces the generated still image and moving image on the display unit 123 or 306 as necessary. Further, the image capturing apparatus 100 or the information terminal 300 transmits the generated still image and moving image to the recording apparatus 400, and the recording apparatus 400 records the received still image and moving image.

The recording apparatus 400 is communicably connected to the image capturing apparatus 100 and the information terminal 300 via the network. The recording apparatus 400 is a cloud storage or a server, which manages the recorded data. However, the recording apparatus 400 can be the recording medium 152 arranged on the image capturing apparatus 100 or the recording medium 310 arranged on the information terminal 300.

The recording apparatus 400 according to the present exemplary embodiment records a product such as a generated three-dimensional model or the like and the plurality of two-dimensional RAW images from which the product is generated in association with each other.

Various methods are provided for “association”. For example, files may be associated with each other by applying common and unique prefix and suffix characters to the file names, by collectively managing files in one folder by creating the one folder, or by recording file names related to a header or footer portion of the files. However, the association method is not limited in particular, as long as association between the files can be recognized.

The two-dimensional RAW images recorded in the recording apparatus 400 are accessible from both of the image capturing apparatus 100 and the information terminal 300. Accordingly, an apparatus which neither accepts an image capturing instruction nor generates an image can generate a new image based on the two-dimensional RAW images recorded in the recording apparatus 400.

In a case where the recording apparatus 400 is the recording medium 152 of the image capturing apparatus 100, the image capturing apparatus 100 records a product such as a generated three-dimensional model or the like and the plurality of two-dimensional RAW images in the recording medium 152 in association with each other. In this case, the information terminal 300 can access the plurality of two-dimensional RAW images recorded in the recording medium 152 of the image capturing apparatus 100, so that the information terminal 300 can generate a new image based on the plurality of two-dimensional RAW images recorded in the recording medium 152.

In a case where the recording apparatus 400 is the recording medium 310 of the information terminal 300, the information terminal 300 records a product such as a generated three-dimensional model or the like and the plurality of two-dimensional RAW images in the recording medium 310 in association with each other. In this case, the image capturing apparatus 100 can access the plurality of two-dimensional RAW images recorded in the recording medium 310 of the information terminal 300, so that the image capturing apparatus 100 can generate a new image based on the plurality of two-dimensional RAW images recorded in the recording medium 310.

Further, in a case where the recording apparatus 400 is the recording medium 310 of the smartphone 300a, the smartphone 300a records a product such as a generated three-dimensional model or the like and the plurality of two-dimensional RAW images in the recording medium 310 in association with each other. In this case, the PC 300b can access the plurality of two-dimensional RAW images recorded in the recording medium 310 of the smartphone 300a, so that the PC 300b can generate a new image based on the plurality of two-dimensional RAW images recorded in the recording medium 310.

As described above, in the image processing system according to the present exemplary embodiment, the image capturing apparatus 100 or the information terminal 300 can generate an image again based on the plurality of two-dimensional RAW images recorded in the recording apparatus 400.

Next, an effect acquired by always recording the plurality of two-dimensional RAW images in the recording apparatus 400 in association therewith regardless of a type of the image capturing instruction is described with respect to each of cases.

### First Case

A first case is described with respect to a case where after a three-dimensional model is generated by a predetermined apparatus, or generated for a predetermined purpose of use, a three-dimensional model or the like is generated by another apparatus, or generated for another purpose of use. In a case where a product is recorded when a three-dimensional model or the like is firstly generated to suit one purpose of use or a processing capacity of one apparatus which generates the three-dimensional model or the like, there is a possibility that the product is not appropriate for another apparatus or another purpose of use. For example, in a case where a product downsized to suit one apparatus having a low processing capacity is reproduced by another apparatus having a higher processing capacity, the product is reproduced with poor rendering quality. Further, a product generated to suit a large-screen display apparatus has a data size too large to be reproduced by a smartphone having a small screen.

According to the present exemplary embodiment, a plurality of two-dimensional RAW images, from which the product is generated, is always recorded in association therewith regardless of the apparatus which firstly generates the image. Therefore, based on the plurality of two-dimensional RAW images, an appropriate three-dimensional model or the like can newly be generated according to a purpose of use and an apparatus which newly generates the three-dimensional model or the like. Further, even in a case where a two-dimensional still image is generated according to a two-dimensional still image capturing instruction when the image capturing is executed first time, a three-dimensional still image can be generated by using the plurality of two-dimensional RAW images recorded in association therewith, without executing the image capturing later. As described above, even in a case where a three-dimensional still image or a three-dimensional moving image is to be newly generated for a different purpose of use, it is possible to generate a three-dimensional model appropriate for another apparatus or another purpose of use.

### Second Case

A second case is described with respect to a case where image processing is executed on a three-dimensional model again. In consideration of the entire color balance and an object of interest, image processing is firstly executed on the two-dimensional RAW images through a general-purpose method before a three-dimensional model is generated from the two-dimensional RAW images. Then, a three-dimensional model is generated from the two-dimensional RAW images after the image processing is executed. However, in a case where the three-dimensional model is recorded when the three-dimensional model is to be used for a purpose different from the initial purpose of use, e.g., when the user would like to change the overall impression of the image or to change the object of interest, the image processing becomes complicated because a general-purpose image processing method cannot be employed.

In the present exemplary embodiment, the plurality of two-dimensional RAW images from which the three-dimensional model is generated is recorded in association therewith. Therefore, image processing can be executed on the recorded two-dimensional RAW images by employing a general-purpose method. Thereafter, a three-dimensional model can be generated again, so that it is possible to generate a three-dimensional model appropriate for the apparatus or the purpose of use.

### Third Case

A third case is described with respect to a case where resolution of a polygon of a three-dimensional model is changed depending on the apparatus or the purpose of use. Because the two-dimensional RAW image has the largest amount of information, a polygon and a texture of the three-dimensional model can be generated with high resolution and high image quality by using the two-dimensional RAW image as it is. On the other hand, there is a case where the apparatus may be overloaded, or resolution of the product is too high for the display apparatus depending on the processing capacity of the apparatus, because a data amount of the product is increased. Therefore, using the two-dimensional RAW image as it is may not always be appropriate for the apparatus or the purpose of use. On the contrary, the rendering quality is degraded if a three-dimensional model is generated based on the two-dimensional images whose data amount is simply reduced.

In the present exemplary embodiment, the image capturing apparatus 100 or the information terminal 300 always acquires a plurality of two-dimensional RAW images regardless of the image capturing instruction. Therefore, it is possible to generate a downsized two-dimensional image having a small amount of information based on the two-dimensional RAW images having a large amount of information. The recording apparatus 400 records the plurality of two-dimensional RAW images in association therewith, and also records the plurality of downsized two-dimensional images in association therewith. Generally, the rendering quality is less likely to be degraded even if resolution of polygon mesh is low. However, the rendering quality tends to be degraded unless a texture of the surface image maintains high resolution. Accordingly, a polygon having appropriate resolution is generated by using the two-dimensional images acquired by downsizing the original two-dimensional RAW images when a polygon is generated. Then, a texture is generated by using the two-dimensional images developed from the two-dimensional RAW images having the original size. In other words, when another apparatus generates a three-dimensional model in the course of generating an image from a plurality of two-dimensional RAW images, the three-dimensional model is generated by making the resolution of the two-dimensional images used to generate a polygon of the three-dimensional model be lower than the resolution of the two-dimensional RAW images used to generate a texture of the three-dimensional model. In this way, a three-dimensional model having a size appropriate for the processing capacity can be generated without deteriorating the rendering quality of the product reproduced by the display apparatus, and a three-dimensional model appropriate for another apparatus or another purpose of use can be generated. Herein, although the processing is described with respect to the case where another apparatus generates an image from a plurality of two-dimensional RAW images, the aspect of the embodiments is also applicable to a case where an apparatus which accepts an image capturing instruction generates an image from the plurality of two-dimensional RAW images.

### Fourth Case

A fourth case is described with respect to a case where a plurality of two-dimensional images having data sizes of different compression rates is recorded depending on whether a two-dimensional still image/moving image is generated or a three-dimensional model or the like is generated. In a case where a two-dimensional still image, a two-dimensional moving image, or a texture of a three-dimensional model is to be generated, a plurality of two-dimensional images have high resolution in order to ensure the rendering quality. On the other hand, in a case where a polygon of the three-dimensional model is to be generated, the rendering quality is less likely to be degraded even if the plurality of two-dimensional images has relatively low resolution.

In the present exemplary embodiment, a plurality of two-dimensional RAW images acquired by the image capturing apparatus 100 or the information terminal 300 is recorded at a compression rate appropriate for the purpose of use. In other words, from among the plurality of acquired two-dimensional RAW images, two-dimensional RAW images used when a two-dimensional still image or a two-dimensional moving image and a texture of a three-dimensional model are generated are separated from two-dimensional RAW images used when a polygon of a three-dimensional model is generated. In order to maintain high image quality, the former two-dimensional RAW images are either uncompressed or compressed at a low compression rate. On the other hand, the latter two-dimensional RAW images are compressed at a high compression rate in order to reduce the data amount. Then, these two-dimensional RAW images are recorded as a plurality of two-dimensional images in association therewith. As described above, from among the plurality of two-dimensional images acquired by the image capturing apparatus 100 or the information terminal 300, the two-dimensional images used when a polygon of the three-dimensional model is generated are recorded at the resolution lower than the resolution of the two-dimensional images used when a texture of the three-dimensional model is generated. In this way, a three-dimensional model having a size appropriate for a processing capacity can be generated without deteriorating the rendering quality of the product reproduced by the display apparatus, and a three-dimensional model appropriate for another apparatus or another purpose of use can be generated.

In addition, as long as the two-dimensional images, from which the three-dimensional model is generated, are recorded in association therewith, a three-dimensional model can newly be generated even if the generated three-dimensional model is not recorded. Accordingly, the recording apparatus 400 does not always have to record the three-dimensional model. However, it is beneficial to record the three-dimensional models in association with the plurality of two-dimensional images because there is a case where the three-dimensional model can be used as it is. It is possible to optionally determine whether to record the three-dimensional model depending on the processing capacity, a memory size, and a recording speed. Similarly, although the products such as a two-dimensional still image, a two-dimensional moving image, a three-dimensional still image, and a three-dimensional moving image do not always have to be recorded, it is beneficial to record these products in association with the plurality of two-dimensional images.

Here, the present exemplary embodiment is supplementally described with respect to the three-dimensional moving image.

Two-dimensional images can be generated from each of frames of a plurality of moving images having parallax, and a three-dimensional model can be generated for each of the frames of the moving images based on the two-dimensional images generated from each of the frames. Then, a moving image of the three-dimensional model can be generated by continuously reproducing the three-dimensional model generated for each of the frames. In a case where a three-dimensional moving image is generated in the image processing system according to the present exemplary embodiment, a plurality of two-dimensional RAW images from which the three-dimensional model is generated for each of the frames is transmitted to the recording apparatus 400 from the image capturing apparatus 100 via the information terminal 300. The recording apparatus 400 records the plurality of two-dimensional RAW images for each of frames in association therewith. As described above, various methods are provided for “association”. As described above, because the plurality of two-dimensional RAW images of each of frames from which the three-dimensional moving image is generated is recorded in association therewith, a three-dimensional model appropriate for the apparatus or the purpose of use can be generated in a similar way to the three-dimensional still image. Further, as described above, it is possible to optionally determine whether to record the three-dimensional model. Furthermore, it is not necessary to record the two-dimensional images of all of the frames, and the two-dimensional images may be thinned out and recorded as necessary.

The present exemplary embodiment is also supplementally described with respect to bracket image capturing. A bracket image capturing mode is provided as an image capturing mode which allows the user to continuously capture two-dimensional still images or three-dimensional still images at different shutter speeds and different aperture values. When the bracket image capturing is executed, a plurality of two-dimensional RAW images acquired through the image capturing operations under different image capturing conditions is transmitted to the recording apparatus 400 from the image capturing apparatus 100 via the information terminal 300. The recording apparatus 400 records the two-dimensional RAW images acquired under all of the image capturing conditions in association therewith. Accordingly, image processing can be executed based on the plurality of two-dimensional images acquired through the bracket image capturing, and a three-dimensional model appropriate for the apparatus or the purpose of use can be generated.

Here, a specific example is described with respect to bracket image capturing of three-dimensional still images executed by the image capturing apparatus 100 which acquires optical images formed by light fluxes passing through different pupil regions. In one embodiment, an aperture is widened when a polygon of a three-dimensional model is generated because a baseline length becomes relatively long. On the other hand, when a texture of the three-dimensional model is generated, in another embodiment, an aperture is narrowed so that a wide range can be brought into focus. Therefore, bracket image capturing is executed under a condition where the aperture is widened and a condition where the aperture is narrowed, images acquired under the former condition are used to generate a polygon of the three-dimensional model, whereas images acquired under the latter condition are used to generate a texture of the three-dimensional model. In this way, it is possible to generate a three-dimensional model with excellent rendering quality. The recording apparatus 400 records the two-dimensional RAW images acquired with the widened aperture and the two-dimensional RAW images acquired with the narrowed aperture in association therewith, so that a three-dimensional model appropriate for the apparatus or the purpose of used can be generated even in a case where the bracket image capturing is executed.

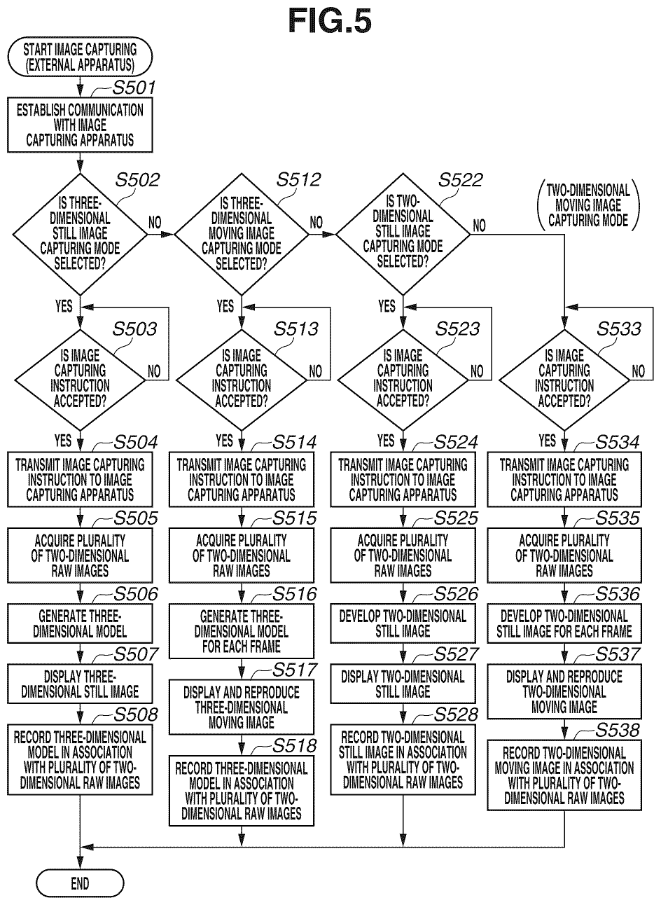

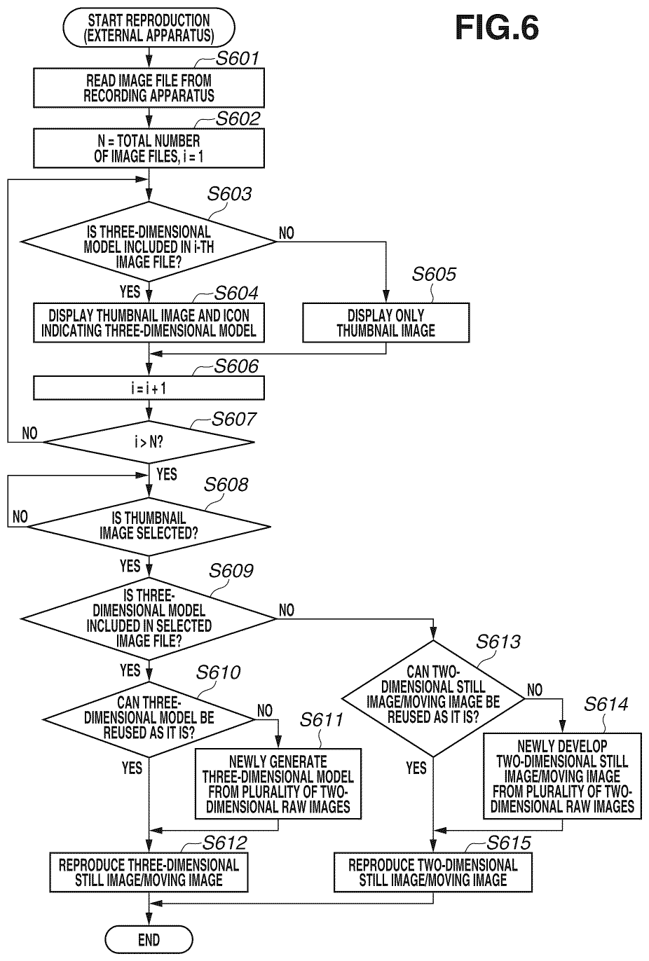

Next, the processing executed by the image processing system according to the present exemplary embodiment is described with reference to flowcharts in FIGS. 5 and 6. The processing illustrated in the flowcharts in FIGS. 5 and 6 is implemented by the control units of respective apparatuses executing programs. FIG. 5 is a flowchart illustrating an example of image capturing processing. This processing is started when the image capturing apparatus 100, the information terminal 300, and the recording apparatus 400 are activated. Here, the processing is described with respect to a case where the information terminal 300 serving as the external apparatus accepts an image capturing instruction.

In step S501, the control unit 301 of the information terminal 300 connects to the image capturing apparatus 100 through wired or wireless connection to establish communication.

In each of steps S502, S512, and S522, the control unit 301 of the information terminal 300 determines a selected image capturing mode based on the operation performed by the user through the operation unit 305. In a case where a three-dimensional still image capturing mode is selected (YES in step S502), the processing proceeds to step S503. In a case where a three-dimensional moving image capturing mode is selected (YES in step S512), the processing proceeds to step S513. In a case where a two-dimensional still image capturing mode is selected (YES in step S522), the processing proceeds to step S523. In a case where a two-dimensional moving image capturing mode is selected (NO in step S522), the processing proceeds to step S533.

In each of steps S503, S513, S523, and S533, the control unit 301 of the information terminal 300 determines whether an image capturing instruction is accepted according to the operation performed by the user through the operation unit 305. In a case where the image capturing instruction is accepted (YES in each of steps S503, S513, S523, and S533), the processing proceeds to each of steps S504, S514, S524, and S534. In a case where the image capturing instruction is not accepted (NO in each of steps S503, S513, S523, and S533), the control unit 301 waits for the image capturing instruction.

In each of steps S504, S514, S524, and S534, the control unit 301 of the information terminal 300 notifies the image capturing instruction to the image capturing apparatus 100. At this time, the image capturing instruction includes information about a type of the image capturing instruction (i.e., a three-dimensional still image, a three-dimensional moving image, a two-dimensional still image, or a two-dimensional moving image) corresponding to the selected image capturing mode. The control unit 161 of the image capturing apparatus 100 controls the image sensor unit 102 according to the image capturing instruction to make the image sensor unit 102 capture a plurality of two-dimensional images having parallax. The control unit 161 of the image capturing apparatus 100 transmits the plurality of two-dimensional RAW images having parallax captured by the image sensor unit 102 to the information terminal 300 which accepts the image capturing instruction from the user.

In each of steps S505, S515, S525, and S535, the control unit 301 of the information terminal 300 receives and acquires the plurality of two-dimensional RAW images transmitted from the image capturing apparatus 100. As described above, in the image processing system according to the present exemplary embodiment, the information terminal 300 acquires the plurality of two-dimensional RAW images regardless of a type of the image capturing instruction.

In each of steps S506, S516, S526, and S536, based on the plurality of acquired two-dimensional RAW images, the control unit 301 of the information terminal 300 generates an image according to a type of the image capturing instruction.

Specifically, a three-dimensional model is generated in step S506, a three-dimensional model is generated for each of frames in step S516, a two-dimensional still image is generated in step S526, and a two-dimensional still image is generated for each of frames in step S536.

In each of steps S507, S517, S527, and S537, the control unit 301 of the information terminal 300 displays the generated image on the display unit 306.

Specifically, in step S507, a three-dimensional still image is displayed based on the generated three-dimensional model. In step S517, a three-dimensional moving image is displayed and reproduced based on the generated three-dimensional models.

Further, in step S527, a developed two-dimensional still image is displayed. In step S537, a developed two-dimensional moving image is displayed and reproduced.

In each of steps S508, S518, S528, and S538, the control unit 301 of the information terminal 300 transmits the generated product and the plurality of acquired two-dimensional RAW images to the recording apparatus 400 in order to record the product and the plurality of two-dimensional RAW images in association with each other. The recording apparatus 400 records the generated product and the plurality of two-dimensional RAW images in association with each other, and also records the plurality of two-dimensional RAW images in association with each other.

In step S508, the three-dimensional model (or the three-dimensional still image) and the plurality of two-dimensional RAW images are recorded in association with each other. In step S518, the three-dimensional models (or the three-dimensional moving image) and the plurality of two-dimensional RAW images are recorded in association with each other. In step S528, the two-dimensional still image and the plurality of two-dimensional RAW images are recorded in association with each other. In step S538, the two-dimensional moving image and the plurality of two-dimensional RAW images are recorded in association with each other.

In addition, in each of steps S508, S518, S528, and S538, the product and the plurality of two-dimensional RAW images may be recorded in the recording medium 310 of the information terminal 300 instead of the recording apparatus 400.

Further, in the flowchart in FIG. 5, although the control unit 301 of the information terminal 300 executes the processing, the processing executed by the control unit 301 of the information terminal 300 may be executed by the control unit 161 of the image capturing apparatus 100.

In a case where a purpose of use is specified, a plurality of predetermined RAW images can be recorded in association with each other. Specifically, in a case where the purpose of generating an image later is to generate a two-dimensional image, the recording apparatus 400 receives an addition RAW image of images A and B and a RAW image or a low-compression RAW image of the image A, and records both of the addition RAW image and the RAW image or the low-compression RAW image of the image A in association with each other. This is because the two-dimensional image is to have high resolution because the purpose of generating the two-dimensional image later is to execute image processing or refocusing processing. On the other hand, in a case where the purpose of generating an image later is to generate a three-dimensional image, the recording apparatus 400 receives an addition RAW image of the images A and B and a high-compression RAW image of the image A, and records both of the RAW images in association with each other. This is because the image A may have low resolution because the purpose of generating the three-dimensional image later is to generate a three-dimensional model. By recording the high-compression RAW image for the image A, an amount of data recorded in the recording apparatus 400 can be reduced.

FIG. 6 is a flowchart illustrating an example of reproduction processing. This processing is started when the information terminal 300 and the recording apparatus 400 are activated. Here, the reproduction processing is described with respect to a case where a reproduction operation is accepted by the information terminal 300 (e.g., PC 300b) different from the information terminal 300 (e.g., smartphone 300a) which accepts the image capturing instruction in the flowchart in FIG. 5.

In step S601, the control unit 301 of the information terminal 300 reads out an image file from the recording apparatus 400 according to the reproduction operation performed by the user via the operation unit 305.

In step S602, the control unit 301 of the information terminal 300 assigns a total number of read image files to N, and assigns 1 to a variable i.

In step S603, the control unit 301 of the information terminal 300 determines whether a three-dimensional model is included in the i-th image file.

In a case where a three-dimensional model is included (YES in step S603), the processing proceeds to step S604. In step S604, the control unit 301 of the information terminal 300 displays an icon indicating presence of the three-dimensional model and a thumbnail image on the display unit 306. In a case where a three-dimensional model is not included (NO in step S603), the processing proceeds to step S605. In step S605, the control unit 301 of the information terminal 300 displays a thumbnail image on the display unit 306.

In step S606, the control unit 301 of the information terminal 300 increments the variable i.

In step S607, the control unit 301 of the information terminal 300 determines whether the variable i is greater than the total number N, and displays all of thumbnail images by repeatedly executing the processing in steps S603 to S607 until the variable i becomes greater than the total number N.

In step S608, the control unit 301 of the information terminal 300 determines whether a thumbnail image is selected through the operation performed by the user via the operation unit 305. In a case where a thumbnail image is selected (YES in step S608), the processing proceeds to step S609. In a case where a thumbnail image is not selected (NO in step S608), the control unit 301 waits until a thumbnail image is selected.

In step S609, the control unit 301 of the information terminal 300 determines whether a three-dimensional model is included in an image file corresponding to the selected thumbnail image. In a case where a three-dimensional model is included (YES in step S609), the processing proceeds to step S610. In a case where a three-dimensional model is not included (NO in step S609), the processing proceeds to step S613.

In step S610, the control unit 301 of the information terminal 300 determines whether the three-dimensional model or the like can be reused as it is. Specifically, the control unit 301 determines whether the three-dimensional model or the like can be reused based on the processing capacity of the information terminal 300, a screen size of the display unit 306, and the user's purpose of use. In a case where the control unit 301 determines that the three-dimensional model or the like can be reused (YES in step S610), the processing proceeds to step S612. In a case where the control unit 301 determines that the three-dimensional model or the like cannot be reused (NO in step S610), the processing proceeds to step S611.

In step S611, the control unit 301 of the information terminal 300 acquires the plurality of two-dimensional RAW images recorded in the recording apparatus 400 in association with the three-dimensional model or the like, and newly generates a three-dimensional model based on the plurality of acquired two-dimensional RAW images. At this time, the control unit 301 generates the three-dimensional model according to the processing capacity of the information terminal 300, a screen size of the display unit 306, and the purpose of use. Accordingly, a three-dimensional model different from the three-dimensional model recorded in the recording apparatus 400 is newly generated.

In step S612, the control unit 301 of the information terminal 300 generates a three-dimensional still image or a three-dimensional moving image from the reused three-dimensional model or the newly-generated three-dimensional model, and displays and reproduces the three-dimensional still image or the three-dimensional moving image on the display unit 306. A newly-generated image is an image at least any of an image type, image resolution, an image size, and a frame rate is different from that of the three-dimensional model or the like recorded in the recording apparatus 400. However, the newly-generated image may be the same as the three-dimensional model or the like recorded in the recording apparatus 400.

On the other hand, in a case where the processing proceeds to step S613 from step S609, the selected image file includes a two-dimensional still image or a two-dimensional moving image.

In step S613, the control unit 301 of the information terminal 300 determines whether the two-dimensional still image or the two-dimensional moving image can be reused as it is. Specifically, the control unit 301 determines whether the two-dimensional still image or the two-dimensional moving image can be reused based on the processing capacity of the information terminal 300, a screen size of the display unit 306, and the user's purpose of use. In a case where the control unit 301 determines that the two-dimensional still image or the two-dimensional moving image can be reused (YES in step S613), the processing proceeds to step S615. In a case where the control unit 301 determines that the two-dimensional still image or the two-dimensional moving image cannot be reused (NO in step S613), the processing proceeds to step S614.

In step S614, the control unit 301 of the information terminal 300 acquires the plurality of two-dimensional RAW images recorded in the recording apparatus 400 in association with the two-dimensional still image or the two-dimensional moving image. The control unit 301 of the information terminal 300 newly generates a two-dimensional still image or a two-dimensional moving image by developing the plurality of acquired two-dimensional RAW images. Accordingly, a two-dimensional still image or a two-dimensional moving image different from the two-dimensional still image or the two-dimensional moving image recorded in the recording apparatus 400 is newly generated.

In step S615, the control unit 301 of the information terminal 300 displays and reproduces the reused two-dimensional still image/two-dimensional moving image or the newly-generated two-dimensional still image/two-dimensional moving image on the display unit 306. A newly-generated image is an image at least any of an image type, image resolution, an image size, and a frame rate is different from that of the two-dimensional still image or the two-dimensional moving image recorded in the recording apparatus 400. However, the newly-generated image may be the same as the image recorded in the recording apparatus 400.

In addition, although a three-dimensional model is generated in step S611, the aspect of the embodiments is not limited thereto. In other words, in step S611, in a case where the user's purpose of use is to generate a two-dimensional still image or a two-dimensional moving image, the control unit 301 can newly generate a two-dimensional still image or a two-dimensional moving image based on the plurality of two-dimensional RAW images recorded in the recording apparatus 400.

Similarly, although a two-dimensional still image or a two-dimensional moving image is generated in step S614, the aspect of the embodiments is not limited thereto. In other words, in step S614, in a case where the user's purpose of use is to generate a three-dimensional still image or a three-dimensional moving image, the control unit 301 can newly generate a three-dimensional model or the like based on the plurality of two-dimensional RAW images recorded in the recording apparatus 400.

Further, although the processing in the flowchart in FIG. 6 is executed by the information terminal 300 (e.g., PC 300b) different from the information terminal 300 (e.g., smartphone 300a) which accepts the image capturing instruction in the flowchart in FIG. 5, the aspect of the embodiments is not limited thereto. For example, the processing may be executed by the information terminal 300 which accepts the image capturing instruction or the control unit 161 of the image capturing apparatus 100.

As described above, according to the present exemplary embodiment, a plurality of two-dimensional images are always recorded in association therewith regardless of a type of the image capturing instruction. Accordingly, it is possible to generate an image appropriate for the apparatus or the purpose of use because a new image can be generated based on the plurality of two-dimensional images recorded in association therewith.

In the above-described exemplary embodiment, the images recorded in association therewith are two-dimensional RAW images. Because the two-dimensional

RAW image includes a greatest amount of information, it is most effective to use the two-dimensional RAW image to generate a new image. However, images to be recorded in association therewith are not limited to the two-dimensional RAW images, and an effect equivalent to the effect achieved by the two-dimensional RAW images can also be acquired by data acquired by compressing the two-dimensional RAW image at a low compression rate or bitmap data sufficiently retaining the resolution and gradation.

Further, although the above-described exemplary embodiment is mainly described with respect to the case where a plurality of two-dimensional images having parallax is captured by a single image capturing apparatus 100, the aspect of the embodiments is not limited thereto. The image processing system may include a plurality of image capturing apparatuses 100 for capturing an object from a plurality of directions, so that a plurality of two-dimensional images having parallax can be acquired by the plurality of image capturing apparatuses 100 respectively capturing two-dimensional images.

### Other Exemplary Embodiments

The disclosure can be realized through processing in which a program for implementing one or more functions according to the above-described exemplary embodiments is supplied to a system or an apparatus via a network or a storage medium, and one or more processors of a computer in the system or the apparatus read and execute the program. Further, the disclosure can also be realized with a circuit (e.g., application specific integrated circuit (ASIC)) which implements one or more functions.

While the disclosure has been described in detail based on the exemplary embodiments, it is to be understood that the disclosure is not limited to the above-described specific exemplary embodiments, and many variations which do not depart from the essential spirit of the disclosure are also included within the scope of the disclosure. Further, a part of the above-described exemplary embodiments may be combined as appropriate.

In addition, disclosure of the present exemplary embodiments includes the following configurations, method, program, and storage medium.

### Configuration 1

An image processing system includes an image capturing apparatus, an external apparatus, and a recording apparatus, wherein the image capturing apparatus includes an image capturing unit configured to capture a plurality of two-dimensional images having parallax according to an image capturing instruction from among image capturing instructions of a plurality of types, wherein at least any one of the image capturing apparatus and the external apparatus includes an acquisition unit configured to acquire the plurality of two-dimensional images captured by the image capturing unit regardless of a type of the image capturing instruction and a first generation unit configured to generate an image according to the type of the image capturing instruction based on the plurality of two-dimensional images acquired by the acquisition unit, and wherein the recording apparatus records the plurality of two-dimensional images captured by the image capturing unit in an association manner.

### Configuration 2

The image processing system according to Configuration 1, wherein at least any one of the image capturing apparatus and the external apparatus further includes a second generation unit configured to newly generate an image based on the plurality of two-dimensional images recorded in the recording apparatus.

### Configuration 3

The image processing system according to Configuration 1, wherein the image processing system further includes the plurality of external apparatuses, wherein a first external apparatus from among the plurality of external apparatuses includes the acquisition unit and the first generation unit, and wherein a second external apparatus from among the plurality of external apparatuses includes a second generation unit configured to newly generate an image based on the plurality of two-dimensional images recorded in the recording apparatus.

### Configuration 4

The image processing system according to Configuration 2 or 3, wherein an image generated by the first generation unit and an image generated by the second generation unit are images at least any of an image type, image resolution, an image size, and a frame rate is different.

### Configuration 5

The image processing system according to Configuration 4, wherein at least a two-dimensional still image, a two-dimensional moving image, a three-dimensional still image, and a three-dimensional moving image are included in the image type.

### Configuration 6

The image processing system according to any one of Configurations 1 to 5, wherein the recording apparatus records the image generated by the first generation unit and the plurality of two-dimensional images in association with each other.

### Configuration 7

The image processing system according to any one of Configurations 1 to 6, wherein the recording apparatus records a three-dimensional model generated by the first generation unit and the plurality of two-dimensional images in association with each other.

### Configuration 8

The image processing system according to any one of Configurations 1 to 7, wherein the plurality of two-dimensional images is two-dimensional RAW images.

### Configuration 9

The image processing system according to any one of Configurations 1 to 8, wherein the recording apparatus is arranged on any one of the image capturing apparatus and the external apparatus.

### Configuration 10

The image processing system according to any one of Configurations 1 to 8, wherein the recording apparatus is communicably connected to at least any one of the image capturing apparatus and the external apparatus via a network.

### Configuration 11

The image processing system according to any one of Configurations 2 to 5, wherein, in a case where a three-dimensional model is to be generated in a course of generating an image based on the plurality of two-dimensional images, the first generation unit or the second generation unit makes resolution of a two-dimensional image used to generate a polygon of the three-dimensional model be lower than resolution of a two-dimensional image used to generate a texture of the three-dimensional model and generates the three-dimensional model.

### Configuration 12

The image processing system according to any one of Configurations 1 to 11, wherein, the recording apparatus makes resolution of a two-dimensional image from among the plurality of two-dimensional images, used to generate a polygon of a three-dimensional model, be lower than resolution of a two-dimensional image used to generate a texture of the three-dimensional model and records the plurality of two-dimensional images.

### Method 1

A control method of an image processing system including an image capturing apparatus, an external apparatus, and a recording apparatus includes capturing a plurality of two-dimensional images having parallax, by image capturing through the image capturing apparatus, according to an image capturing instruction from among image capturing instructions of a plurality of types, acquiring the plurality of two-dimensional images captured by the image capturing, through at least any one of the image capturing apparatus and the external apparatus, regardless of a type of the image capturing instruction, and generating an image according to the type of the image capturing instruction, by first generation through at least any one of the image capturing apparatus and the external apparatus, based on the plurality of two-dimensional images acquired by the acquiring, wherein the recording apparatus records the plurality of two-dimensional images captured by the image capturing in an association manner.

### Program 1

A program which causes a computer to execute the control method of the image processing system according to Method 1.

### Storage Medium 1

A non-transitory computer-readable storage medium storing a program for causing a computer to execute the control method of the image processing system according to Method 1.

According to the aspect of the embodiments, it is possible to generate an appropriate image depending on an apparatus or a purpose of use.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-163152, filed Sep. 26, 2023, which is hereby incorporated by reference herein in its entirety.

What is claimed is:

1. A system comprising:
a capturing apparatus;
an external apparatus; and
a recording apparatus,
wherein the capturing apparatus includes:
one or more processors; and
a memory storing instructions which, when executed by the one or more processors, cause the capturing apparatus to function as:
a capturing unit configured to capture a plurality of two-dimensional images having parallax according to an instruction from among instructions of a plurality of types,
wherein at least any one of the capturing apparatus and the external apparatus includes:
one or more processors; and
a memory storing instructions which, when executed by the one or more processors, cause the at least any one of the capturing apparatus and the external apparatus to function as:
an acquisition unit configured to acquire the captured plurality of two-dimensional images regardless of a type of the instruction; and
a first generation unit configured to generate an image according to the type of the instruction based on the acquired plurality of two-dimensional images, and
wherein the recording apparatus records the captured plurality of two-dimensional images in an association manner.

2. The system according to claim 1, wherein at least any one of the capturing apparatus and the external apparatus further includes a second generation unit configured to newly generate an image based on the plurality of two-dimensional images recorded in the recording apparatus.

3. The system according to claim 1,
wherein the system further comprises the plurality of external apparatuses,
wherein a first external apparatus from among the plurality of external apparatuses includes the acquisition unit and the first generation unit, and
wherein a second external apparatus from among the plurality of external apparatuses includes a second generation unit configured to newly generate an image based on the plurality of two-dimensional images recorded in the recording apparatus.

4. The system according to claim 2, wherein an image generated by the first generation unit and an image generated by the second generation unit are images at least any of a type, resolution, a size, and a frame rate is different.

5. The system according to claim 4, wherein at least a two-dimensional still image, a two-dimensional moving image, a three-dimensional still image, and a three-dimensional moving image are included in the type.

6. The system according to claim 1, wherein the recording apparatus records the image generated by the first generation unit and the plurality of two-dimensional images in association with each other.

7. The system according to claim 1, wherein the recording apparatus records a three-dimensional model generated by the first generation unit and the plurality of two-dimensional images in association with each other.

8. The system according to claim 1, wherein the plurality of two-dimensional images is two-dimensional RAW images.

9. The system according to claim 6, wherein the recording apparatus is arranged on any one of the capturing apparatus and the external apparatus.

10. The system according to claim 6, wherein the recording apparatus is communicably connected to at least any one of the capturing apparatus and the external apparatus via a network.

11. The system according to claim 2, wherein, in a case where a three-dimensional model is to be generated in a course of generating an image based on the plurality of two-dimensional images, the first generation unit or the second generation unit makes resolution of a two-dimensional image used to generate a polygon of the three-dimensional model be lower than resolution of a two-dimensional image used to generate a texture of the three-dimensional model and generates the three-dimensional model.

12. The system according to claim 1, wherein, the recording apparatus makes resolution of a two-dimensional image from among the plurality of two-dimensional images, used to generate a polygon of a three-dimensional model, be lower than resolution of a two-dimensional image used to generate a texture of the three-dimensional model and records the plurality of two-dimensional images.

13. A method of a system including a capturing apparatus, an external apparatus, and a recording apparatus, the method comprising:
capturing a plurality of two-dimensional images having parallax, by capturing through the capturing apparatus, according to an instruction from among instructions of a plurality of types;
acquiring the captured plurality of two-dimensional images, through at least any one of the capturing apparatus and the external apparatus, regardless of a type of the instruction; and
generating an image according to the type of the instruction, by first generation through at least any one of the capturing apparatus and the external apparatus, based on the plurality of two-dimensional images acquired by the acquiring,
wherein the recording apparatus records the plurality of two-dimensional images captured by the capturing in an association manner.

14. The method according to claim 13, further comprising:
generating an image based on the plurality of two-dimensional images recorded in the recording apparatus.

15. The method according to claim 13, further comprising:
recording the generated image and the plurality of two-dimensional images in association with each other.

16. The method according to claim 13, further comprising:
recording a three-dimensional model generating and the plurality of two-dimensional images in association with each other.

17. A non-transitory computer-readable storage medium storing a program for causing a computer to execute a method of a system including a capturing apparatus, an external apparatus, and a recording apparatus, the method comprising:
capturing a plurality of two-dimensional images having parallax, by capturing through the capturing apparatus, according to an instruction from among instructions of a plurality of types;
acquiring the captured plurality of two-dimensional images, through at least any one of the capturing apparatus and the external apparatus, regardless of a type of the instruction; and
generating an image according to the type of the instruction, by first generation through at least any one of the capturing apparatus and the external apparatus, based on the plurality of two-dimensional images acquired by the acquiring,
wherein the recording apparatus records the plurality of two-dimensional images captured by the capturing in an association manner.

18. The non-transitory computer-readable storage medium according to claim 17, further comprising:
generating an image based on the plurality of two-dimensional images recorded in the recording apparatus.

19. The non-transitory computer-readable storage medium according to claim 17, further comprising:
recording the generated image and the plurality of two-dimensional images in association with each other.

20. The non-transitory computer-readable storage medium according to claim 17, further comprising:
recording a three-dimensional model generating and the plurality of two-dimensional images in association with each other.
